(19) United States
(12) Patent Application Publication
(10) Pub. No.: US 2016/0006921 A1
(43) Pub. Date: Jan. 7, 2016

(54) SYSTEM AND METHOD OF PREDICTING WHETHER A PERSON IN AN IMAGE IS AN OPERATOR OF AN IMAGER CAPTURING THE IMAGE

(71) Applicant: ADIENCE SER LTD., Tel Aviv (IL)

(72) Inventors: Eran Hillel Eidinger, Tel Aviv (IL); Alexander Medvedovsky, Tel Aviv (IL); Roee Nahir, Tel Aviv (IL)

(21) Appl. No.: 14/790,052

(22) Filed: Jul. 2, 2015

Related U.S. Application Data
(60) Provisional application No. 62/020,425, filed on Jul. 3, 2014.

(51) Int. Cl. H04N 5/232; G06F 17/30; H04N 5/225

(52) U.S. Cl. CPC H04N 5/23203; H04N 5/2258; H04N 5/23293; H04N 5/23229; G06F 17/30058; H04N 2101/00

(57) ABSTRACT

Embodiments of the invention include a method of predicting that a person appearing in an image is an operator of a device capturing the image. Embodiments of the method include designating a first person appearing in a first image stored in a storage-unit associated with the device and designating a second person appearing in a second image stored in the storage-unit. Embodiments of the method further include calculating a first probability that the first person is the operator of the device, calculating a second probability that the second person is the operator of the device and comparing the first probability to the second probability.

### CROSS REFERENCE TO RELATED APPLICATIONS

This application claims the benefit of U.S. Provisional Application Ser. No. 62/020,425, filed on Jul. 3, 2014, which is incorporated in its entirety herein by reference.

### BACKGROUND OF THE INVENTION

Electronic devices that have a memory may store significant numbers of images, such as images of people. Such images may be in one or more of various image collections or portfolios on or associated with the device. For example, a gallery of images stored in a memory of the device, may be stored in one or more applications or identifiable services running on the device (such as Facebook™, WhatsApp™ or other social network applications or other identifiable service). Additionally or alternatively, the images may be stored in a collection of images that are sent to the device from other devices or services. It may be useful to identify a person who appears in one or more of the images associated with the device as being a person who operates the device.

### SUMMARY OF THE INVENTION

Embodiments of the invention may include a method of predicting that a person appearing in an image is an operator of a device capturing the image. Embodiments of the method may include designating a first person appearing in a first image stored in a storage-unit associated with the device and designating a second person appearing in a second image stored in the storage-unit. Embodiments of the method may further include calculating a first probability that the first person is the operator of the device, calculating a second probability that the second person is the operator of the device and comparing the first probability to the second probability. Embodiments of the invention may include a method of determining that an image is a self-portrait of a person. Embodiments of the method may include calculating parameters related to a location of a camera capturing the image at the time of capturing of the image and calculating parameters related to the person appearing in the image.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a high level block diagram of a device for capturing images according to some embodiments of the invention;

FIG. 1B is an exemplary device for capturing images according to some embodiments of the invention;

FIGS. 2A, 2B and 2C are illustrations of exemplary images according to some embodiments of the invention; and

FIG. 3 is a flowchart of a method of predicting that a person appearing in an image is an operator of a device capturing the image according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Aspects of the invention may be related to a method of predicting that a person appearing in an image is an operator of a device capturing the image. The device may be a mobile device, such as a mobile cellular telephone or a tablet computer that includes at least one camera. A mobile device according to embodiments of the invention may include an application that sorts, analyses or evaluates images stored in the mobile device, and identifies which one of the persons appearing in the images is most probably the person operating the device. The application may detect several parameters that may predict the identity of the person. For example, the application may look for and identify self-portrait photographs “selfies” by detecting for example the distance of the person from the camera at which the photograph was taken. The application may further detect if one or more persons appearing in more than one selfie also tend to appear in many other images. If one particular person tends to appear in a number of “selfies” and/or in a large number of other images, embodiments of the invention may indicate that the identified person is the person activating the device.

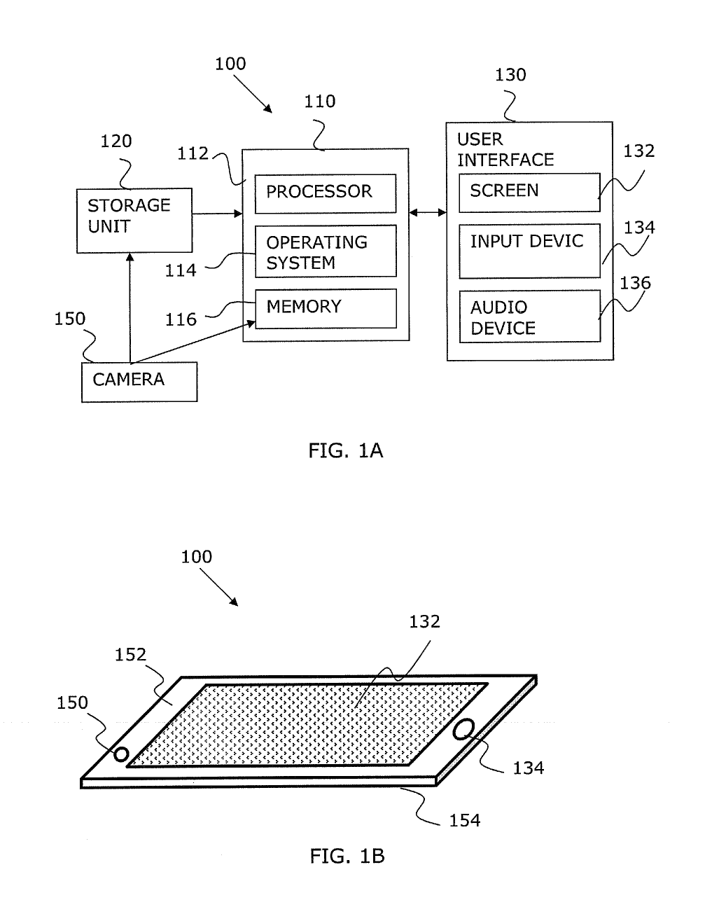

Reference is made to FIG. 1A, which is high level block diagram of an exemplary device for capturing images according to some embodiments of the invention. An embodiment of a device 100 may include a computer processing unit 110, a storage unit 120 and a user interface 130. An embodiment of device 100 may further include at least one camera 150 for capturing images. Processing unit 110 may include a processor 112 that may be, for example, a central processing unit (CPU), a chip or any suitable computing or computational device, an operating system 114 and a memory 116. An embodiment of a device 100 may be included in either mobile or stationary devices, for example, a smart cellular telephone, laptop commuter, a tablet computer, desktop computer, a mainframe computer or the like. Processor 112 or other processors may be configured to carry out methods according to embodiments of the present invention by for example executing instructions stored in a memory such as memory 116.

Operating system 114 may be or may include a code segment or instructions designed or configured to perform tasks involving coordination, scheduling, analysis, supervising, controlling or otherwise managing operation of processing unit 110, for example, scheduling execution of programs. Operating system 114 may include a commercial operating system. Memory 116 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 116 may be or may include more than one memory units.

Memory 116 may store any executable code, e.g., an application, a program, a process, operations, task or script. The executable code may when executed by a processor cause the processor to predict that a person appearing in an image is an operator of device 100, such as the person capturing or storing the image, and may perform methods according to embodiments of the present invention. The executable code may be executed by processor 112 possibly under control of operating system 114.

Storage 120 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 120 and may be loaded from storage 120 into memory 116 where it may be processed by processor 112. For example, storage 120 may include two or more images capture by camera 150 or by any other camera and stored in storage-unit 120. In some embodiments storage unit 120 may further store any other required data according to embodiments of the invention. In some embodiments, storage unit 120 and memory 116 may be included in a single device configured to store both codes to be executed by processor 112 and images.

In some embodiments, images stored in storage unit 120 may include one or more portfolios or collections of images (such as a gallery). In some embodiments, a first portfolio may be stored in a first storage-unit and a second portfolio may be stored in a second storage unit, such as on a remote memory.

User interface 130 may be, be displayed on, or may include a screen 132 (e.g., a monitor, a display, a CRT, etc.). An embodiment of a device 100 may include an input device 134 and an audio device 136. Input device 134 may be a keyboard, a mouse, a touch screen or a pad or any other suitable device that allows a user to communicate with processor 112. Screen 132 may be any display suitable for displaying images according to embodiments of the invention. In some embodiments, screen 132 and input device 134 may be included in a single device, for example, a touch screen. It will be recognized that any suitable number of input devices may be included in user interface 130. Device 100 may include or be associated with audio device 136 such as one or more speakers, earphones, microphone and/or any other suitable audio devices. It will be recognized that any suitable number of output devices may be included in device 100. Any applicable input/output (I/O) devices may be connected to processing unit 110. For example, a wired or wireless network interface card (NIC), a modem, printer or facsimile machine, a universal serial bus (USB) device or external hard drive may be included in user interface 130.

Embodiments of the invention may include an article such as a processor non-transitory readable medium, or a computer or processor non-transitory storage medium (e.g., storage unit 120 and/or memory 116), such as for example a memory, a disk drive, or a USB flash memory, encoding, including or storing instructions, e.g., computer-executable instructions, which, when executed by a processor or controller, carry out methods disclosed herein.

The storage medium may include, but is not limited to, any type of disk including floppy disks, optical disks, compact disk read-only memories (CD-ROMs), re writable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage unit.

Embodiments of device 100 may include or may be, for example, smart phone (as illustrated in FIG. 1B), a personal computer, desktop computer, mobile computer, laptop computer, notebook computer, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Reference is made to FIG. 1B which is an illustration of an exemplary device for capturing images according to some embodiments of the invention. Embodiments of device 100 may include a smart phone or a tablet that may include at least some of the components disclosed in the block diagram of FIG. 1A. In the illustration of device 100 in FIG. 1B, only the visible components of the device are present, for example, screen 132, input device 134 and at least one camera 150. Camera 150 (an imager) may be any capturing device that is configured to capture images. In some embodiments, the captured images may be stored in a memory (e.g., memory 116) or storage-unit (e.g., storage unit 120) or on any other storage unit, for example, a storage unit remotely located on the web (e.g., on a cloud).

In some embodiments, camera 150 may be located on a front-side 152 of device 100. The front-side of device 100 may be defined as the side comprising screen 132. A person looking at screen 132 may simultaneously take a self-portrait (a “selfie”) image using camera 150. In some embodiments, camera 150 may be located on a back-side 154 of device 100. The back-side of device 100 may be defined as a side opposite to screen 132. In some embodiments, device 100 may include more than one camera 150. For example, a first camera 150 may be located on front side 152 and a second camera 150 may be located at back-side 154.

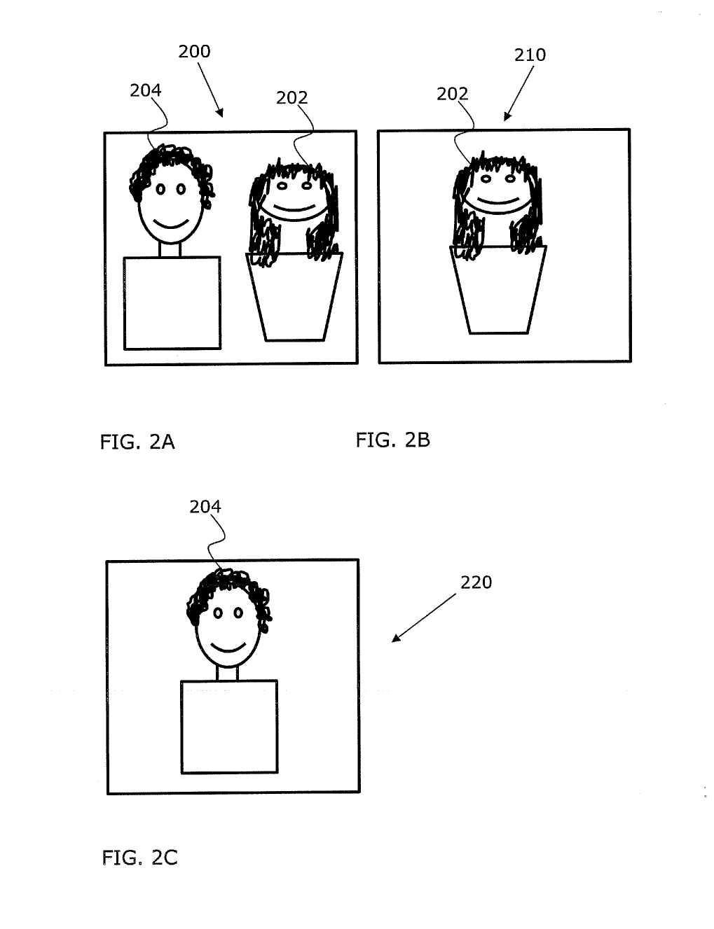

Reference is made to FIGS. 2A-2C, which are schematic illustrations of images according to some embodiments of the invention. An image 200, illustrated in FIG. 2A, may include two or more figures of persons 202 and 204. An image 210, illustrated in FIG. 2B may include a figure of person 202 and an image 220, illustrated in FIG. 2C, may include a figure of persons 204. In some embodiments images 200, 210 and 220 may be stored as image data such as pixels in a memory and/or storage-unit such as storage unite 120. In some embodiments, image 200 may be stored in a first storage-unit (e.g., storage unit 120) and images 210 and 220 may be stored in a different storage unit on device 100 (e.g., memory 116). Alternatively, images 210 and 220 may be stored in a storage-unit that is located remotely from device 100, but that may be accessible to or associated with device 100 by any way of communication. In some embodiments, images 200-220 may be still-images or one or more frames of video images. In some embodiments, one or more of images 200-220 may have been captured by camera 150. At least one of images 200-220 may be taken by an operator of device 100, for example, using camera 150 located on the front side of device 100 (e.g., a “selfie”). In some embodiments, one or more of images 200-220 may have been captured by a camera other than camera 150, and transmitted to device 100 by any way of communication and stored in a storage-unit such as storage-unit 150.

In some embodiments, an image such as images 200-220 may include or be associated with image-data in the form of for example, pixels (image intrinsic data). Additionally or alternatively, the images may be associated with image-data that may not be visible in the images (meta-data or image extrinsic data). Non-limiting example, of such data may include: a data or time of capturing of the image, identification data of the camera that captured the image, data regarding a rate of compression of the image data, a time of receipt or storage of the image data on device 100 or storage-unit 120, a localization data (e.g., a GPS (Global Position System) coordinates) related to the location of device or camera 150 that captured the image during capturing of the image and other data.

In some embodiments, image data representing for example one or more of the faces appearing in images 200-220 may be clustered, gathered, compared, analyzed and evaluated so that, for example, similar or identical faces that appear in two or more images in the portfolio are tagged, designated or noted as likely representing the same person. In some embodiments, a probability or likelihood may be assigned to an assumption or prediction that a face in two or more photos represents a same person. In some embodiments, one or more of images 200-220 may be identified as a self-portrait.

In some embodiments, a prediction, likelihood or probability may be developed or calculated that a person (e.g., persons 202 or 204) identified in two or more of the images may be a person who operated camera 150 as it captured the images, or who owns, controls or is uniquely identified or associated with one or more identifiable services that are associated with the device 100 or camera 150.

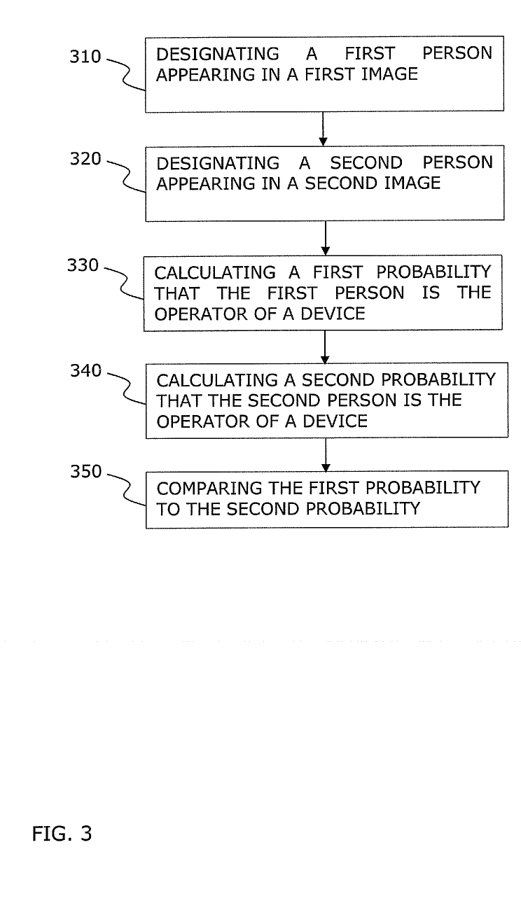

Reference is made to FIG. 3, which is a flowchart of a method of predicting that a person appearing in an image is an operator of a device capturing or storing the image according to some embodiments of the invention. An embodiment of the method of FIG. 3 may be performed, for example, by processing unit 110 or by any other processing unit. In operation 310, an embodiment of the method may include designating a first person appearing in a first image stored in a storage-unit associated with the device. For example, first person 202 may be designated in first image 210. First person 202 may further be designated in an additional image 200. Images 200 and 210 may form a first portfolio of images.

In operation 320, embodiments of the method may include designating a second person appearing in the first image or in a second image. For example, second person 204 may be designated in second image 220. Second person 204 may further be designated in an additional image 200. Images 200 and 220 may form a second portfolio of images.

In operation 330, embodiments of the method may include calculating a first probability that the first person is the operator of the device. The first probability may be calculated based on one or more factors. Some exemplary factors are discussed below. In operation 340, embodiments of the method may include calculating a second probability that the second person is the operator of the device. The second probability may be calculated based on the same factors as the first probability or based on different factors.

Some embodiments of the invention may include a method of determining if an image included in a portfolio of images is a self-portrait (a “selfie”). A self-portrait included in a portfolio may be most probably taken by an operator of device 100. A self-portrait is most likely to be taken by a camera located in the front side of device 100. Embodiments, of such method may include calculating parameters related to a location of a camera capturing the image at the time of capturing of the image and calculating parameters related to person appearing in the image.

In some embodiments, calculating the first and/or second probabilities may include detecting that a camera (e.g., camera 150) capturing at least one of: the first image and the second image may be located on a front of the device. An image taken by a camera located in front of device 100 may be a self-portrait photograph taken by a person appearing in the image. An exemplary parameter related to a location of a camera capturing the image may include the distance between camera 150 and the designated person. The distance may be determined by calculating the distance between camera 150 and the designated person holding the camera at the time of capturing the image. The distance may be calculated, for example, based on a field of view, a focal length, a resolution and an aperture of the camera that captured the image. This data or other meta-data may be stored and associated with the captured image.

Determining that an image is a self-portrait taken by a front camera 150 may include analyzing additional parameters, for example, parameters related to person appearing in the image such as the relative size of a face appearing in an image. An exemplary way to determine if an image was taken by the front camera is by analyzing aspects related to a relative size of the image of a person in the captured image as an indication that the image was captured while the person was holding the device in very close proximity. A size of a face of a person appearing in a self-captured with a camera on the front of a cellular telephone may also be larger than a relative size of a face or portion of an image occupied by the face in an image captured with a camera located at the back of a cellular telephone.

In some embodiments, calculating the first and/or second probabilities may include detecting that a camera (e.g., camera 150) capturing at least one of the first image and the second image is located on a back-side of the device. In some embodiments, the method may include analyzing data related to each image, for example, a relative size of person(s) appearing in the image, the number of persons appearing in the image or the like. If the relative size of persons appearing in the image is small, for example, occupying less than a predetermined percentage of the area of the surface, this image was most probably taken by camera 150 located at the back-side of device 100. Additionally or alternatively, analyzing data related to the image may include analyzing, a meta-data including: a make, a model, a field of view, a focal length, a resolution and an aperture of the camera that captured an image during capturing of the image.

In some embodiments, calculating at least one of the first probability and the second probability may include calculating a portion of the first image that is occupied by a face of the first person, and calculating a portion of the second image that is occupied by the second person. The calculated portion of an image occupied by a face of a person may be another exemplary parameter related to a person appearing in the image. For example, a detection that a face or body of a designated person in the image captures a large portion of the image relative to other items (e.g., other persons) appearing in the image, may deem an indication or part of a prediction that the operator of the camera 150 used camera 150 to take a self-portrait or an image in which the operator himself is included. Determining that an image is a self-portrait may further include calculating that an area occupied by a designated person in an image is larger than a predetermined percentage (e.g., 30%) of the area of the image occupied by other people appearing in the image. This calculation may deem an indication that the designated person captured the image while holding camera 150.

In some embodiments, calculating at least one of the first probability and the second probability may include calculating an orientation in space of a camera capturing one or more of the images or a time of a capture of one or more of the images. The orientation in space may be an exemplary parameter related to a location of a camera capturing the image. For example, a meta-data item associated with the image may include a tilt or orientation in space of camera 150 or device 100 at a time of capturing of the first or second images of the first or second persons. Such data may deem an indication or may determine that the image of the designated person is a self-portrait. For example, capturing a “selfie” may include holding device 100 above a level of the designated person, and tilting the camera down to face the face of the designated person.

In some embodiments, calculating at least one of the first probability and the second probability may include finding a frequency of an appearance of at least one of the first person and the second person in images of a portfolio of images stored in the storage-unit. The method may include sorting a portfolio (e.g., a folder, a gallery, or the like) of images and calculating a frequency or percentage of the images in which appear the first or second person relative to the total number of images in the portfolio. In some embodiments, it may be assumed that an image of a designated person appearing in many of the images in a portfolio may indicate that this person has a strong connection to the portfolio. The assumption may lead to the conclusion that the designated person may be or be strongly associated with an operator of a camera 150 that captured one or more of the images in the portfolio and/or an operator of device 100 storing the portfolio, for example, the designated person may be the operator himself or a close relative of the operator (e.g., a child).

In some embodiments, calculating at least one of the first probability and the second probability may include calculating an angle of at least one of the first person in the first image and the second person in the second image. The calculated angle of a person in an image may be another exemplary parameter related to a person appearing in the image. Calculating an angle may include calculating a respective angle of a certain body part with respect to other body parts of the designated person, appearing in the image. In some embodiments, determining if an image is a self-portrait may include finding an angle of a face of the first person in the first image and/or an angle of the face of the second person in the second image. For example, an appearance in an image of a designated person at an angle or perspective in the image that is indicative of a pronounced closeness of a first portion of the face of the designated person relative to a second portion of the face may deem an indication that the image of the designated person is a self-profile.

In yet another example, another parameter related to a person appearing in the image may include detecting an angle of one or more of body parts, such as, a finger, shoulder, arm or neck of a designated person, in the image. The detection may indicate that the image is a self-profile. For example, an appearance of an arm as extending at an angle that meets or runs parallel to the camera or lens, may be deemed an indication that the portrait is a self-profile.

In some embodiments, calculating at least one of the first probability and the second probability may include detecting in at least one of the first image and the second image a body part, the body part selected from a group consisting of a finger, a hand, an arm and a neck. For example, the method may include detecting a presence in an image or in a corner or foreground of an image of a finger, shoulder, arm or neck of a designated person. An embodiment of the method may further include calculating the relative area captured by the body part. In some embodiments, determining if an image is a self-portrait may include detecting a portion of a body part in the image, the portion occupies an area larger than a predetermined percentage. For example, a selfie may include a portion of an arm, shoulder or large part of a neck of a designated person in, for example, a corner of the image and at close range to the imager. Such presence and size may be used as an indication that the image is a self-portrait of the designated person.

In some embodiments, calculating at least one of the first probability and the second probability may include calculating a position of the first and/or the second person in one or more images stored the storage unit. For example, an appearance of a designated person in or near a center of a group of people in an image may indicate that the person put himself in the middle of the group of people in the image. In yet another example, an appearance of a designated person in or near a back of a group of people in the image may indicate that the person set up the group of people and ran to the back of the group as the image was captured by someone else. This may predict that the person is the designated person operating, controlling or owning the camera that captured the image.

In some embodiments, calculating at least one of the first probability and the second probability may include calculating a first compression rate of data in the first image, and comparing the first compression rate to a second compression rate of data in the second image. In some embodiments, it may be assumed that the first image in a portfolio of images may have been captured with camera 150 while other images in the portfolio may be received from a second device and compressed prior to saving on device 100. The other images may be received from an attachment to an email, a text massage (e.g., SMS or WhatsAppt™) an Instagram™ application, or the like, thus may be compressed to reduce the size of the image file. Original files taken by camera 150 of device 100 may be saved and stored in storage-unit 120 in their original size or in a less compressed form.

In some embodiments, an image of the designated person stored may have a low rate of compression in comparison to a higher rate of compression of an image of the designated person stored in a different memory. The comparison between the compression rates may be included in a prediction that the image on storage unit 120 was captured by camera 150 and stored on device 100 without the compression that may be typical of images transmitted to/from device 100 to another memory unit. In some embodiments, it may be concluded that an image having a high compression rate that was compressed and transmitter from device 100 to an external device is an image taken by the operator of the device.

In some embodiments, calculating at least one of the first probability and the second probability may include comparing a time of capture of the first image to a time of capture of the second image. For example, a meta data item that includes the time (e.g., date and time) associated with a first image stored in device 100, that includes a first person may be compared to a time of capture of a second image. The comparison may indicate that the second image was captured at or around a time of capture of the first image, potentially by the same person or in a related series of images, such as self-portraits that may have been captured by the person or operator.

In some embodiments, calculating at least one of the first probability and the second probability may include determining a location of a capture of the first image and a location of a capture of the second image. For example, a meta-data item that includes the location (e.g., localization data) associated with capturing the first image stored in device 100, that may be associated with a first person may be compared to a location of a capture of a second image. The comparison may indicate that the second image have been captured at or near a location where device 100 was located, at or around a time of the capturing of the first image, potentially by the same person. The localization data may include GPS coordinates or other indications of location coordinates.

In some embodiments, the location of a capture of the first image may be compared to a location whereat device 100 was present at one or more times, such as for example at a time when the first image was captured. For example, a meta-data item associated with one or more images in device 100 that includes the first person may indicate that one or more of such images was captured at or near a location where the device was located at or around a time of a capture of such image. This similarity or identity of locations may deem an indication that the first person owns or controls the camera that captured one or more of the images.

In some embodiments, calculating at least one of the first probability and the second probability may include calculating at least one of a first duration of a period over which images of the first person were captured and stored in the storage unit and a second duration of a period over which images of the second person were captured and stored in the storage unit. For example, it may be assumed that a person (e.g., person 202) operating device 100 may capture and/or save images of himself and store those images in storage unit 120 over a relatively long period of time, for example, more than two months. In comparison, images of a second person (e.g., person 204) may be captured and stored over a relatively short period of time, for example, during a single day or over several days, during which person 202 has encountered person 204 (e.g., during a mutual vacation, family gathering or the like).

In some embodiments, calculating at least one of the first probability and the second probability may include determining a chronology of capture of the first image and a second image stored in the device that include the first person. For example, an appearance of the designated person in a series of images in the portfolio that were captured over a course of several days or other periods may deem an indication that the designated person operated camera 150 during such period or was strongly associated with the person who operated camera 150 during the period.

In some embodiments, calculating at least one of the first probability and the second probability may include determining a first chronology of a storage time of the first image wherein the first person appears and a second chronology of a storage time of the second image wherein the second person appears. For example, an appearance of the designated person in an image stored in the device at a first time, and an appearance of the designated person in a same or similar image stored in another device at a second time, may deem an indication that the first image was first stored on, for example, device 100 by an operator or owner of the device, and then transmitted to a second memory or device where it was stored at a later time. This may be included in a determination that the first image was captured with the device, and then moved or transmitted to another memory.

In some embodiments, calculating at least one of the first probability and the second probability may include comparing an identity of a camera that captured the first image to an identity of a camera that captured the second image. In some embodiments, it may be assumed that the person operating device 100 may capture various images of himself with camera 150 and store such images in storage unit 120. Accordingly, it may be assumed that other person may capture various images of himself using another camera (not included in device 100) and may send the images to the person operating device 100 using, for example, social networks. An identity of a camera may include, for example, a serial number, a model number, or brand of a camera or any other unique identifier. A meta-data item indicating that a particular camera such as camera 150 captured a large number or percentage of the images in the portfolio wherein appeared the designated person, may be part of a determination that the person is strongly associated with camera 150.

In some embodiments, calculating at least one of the first probability and the second probability may include finding an identity or strong similarity among images in a portfolio of images stored in device 100 wherein the designated person appears. For example, an image of the designated person may be stored in a ‘gallery’ application of a mobile device. The same or a similar image may also be stored in a memory associated with an identifiable service used by the device. Images of the person may be used as a profile image on a social network, indicating that the person in the image may be the operator of the device. The one or more of the images may be stored in the ‘gallery’ application and then transmitted to another application or memory associated with the device or the designated person.

In some embodiments, calculating at least one of the first probability and the second probability may include comparing the first person in the first image to an image picture in an identified service (e.g., in social network). Such an image picture may be, for example, a ‘profile’, a contact, a ‘home page’ image or the like. For example, a strong similarity of an image or face of a designated person in an image stored in device 100 to a profile picture on a page of a social network service may deem an indication that the designated person is the person in the profile picture. Meta data of images on identified service may be analyzed to determine whether such images were captured with camera 150

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of predicting that a person appearing in an image is an operator of a device capturing the image, the method comprising:
designating a first person appearing in a first image stored in a storage-unit associated with the device;
designating a second person appearing in a second image stored in the storage-unit;
calculating a first probability that the first person is the operator of the device;
calculating a second probability that the second person is the operator of the device; and
comparing the first probability to the second probability.

2. The method of claim 1, wherein calculating at least one of the first probability and the second probability, comprises detecting that a camera capturing at least one of the first image and the second image was located on a front-side of the device.

3. The method of claim 1, wherein calculating at least one of the first probability and the second probability, comprises detecting that a camera capturing at least one of the first image and the second image is located on a back-side of the device.

4. The method of claim 1, wherein calculating at least one of the first probability and the second probability, comprises calculating a portion of the first image that is occupied by a face of the first person, and calculating a portion of the second image that is occupied by the second person.

5. The method of claim 1, wherein calculating at least one of the first probability and the second probability, comprises calculating an orientation in space of a camera capturing at least one of:
the first image, at a time of a capture of the first image; and
the second image, at a time of a capture of the second image.

6. The method of claim 1, wherein calculating at least one of the first probability and the second probability, comprises finding a frequency of an appearance of at least one of: the first person and the second person, in images stored in the storage-unit.

7. The method of claim 1, wherein calculating at least one of the first probability and the second probability, comprises calculating an angle of at least one of: the first person in the first image and the second person in the second image.

8. The method of claim 1, wherein calculating at least one of: the first probability and the second probability, comprises finding an angle of a face of at least one of: the first person in the first image and the second person in the second image.

9. The method of claim 1, wherein calculating at least one of: the first probability and the second probability, comprises detecting in at least one of the first image and the second image, a body part, the body part selected from a group consisting of: a finger, a hand, an arm and a neck.

10. The method of claim 1, wherein calculating at least one of the first probability and the second probability comprises calculating a position of at least one of: the first and the second person in one or more images stored the storage unit.

11. The method of claim 1, wherein calculating at least one of the first probability and the second probability comprises comparing the first person in the first image to an image in an identified service.

12. A device for capturing images comprising;
a storage-unit configured to store a plurality of images;
a memory configured to store instructions; and
a processor configured to execute the stored instructions, the instructions are to:
designate a first person in a first image stored in the storage-unit;
designate a second person in a second image stored in the storage-unit;
calculate a first probability that the first person is the operator of the device;
calculate a second probability that the second person is the operator of the device; and
compare the first probability to the second probability to determine which one of the first person or the second person is the operator of the device.

13. The device of claim 12, wherein the instruction are to compare first compression rate of data in the first image, to a second compression rate of data in the second image.

14. The device of claim 12, wherein the instruction are to compare a time of capture of the first image to a time of capture of the second image.

15. The device of claim 12, wherein the instructions are to compare a time of storage of the first image in the storage-unit to a time of storage of a the first image in another storage-unit associated with the device.

16. The device of claim 12, wherein the instructions are to calculate duration of a time period over which images of the first person were captured and stored in the storage unit.

17. The device of claim 12, wherein the instructions are to compare an identity of a camera that captured the first image to an identity of a camera that captured the second image.

18. The device of claim 12, wherein the instructions are to determine a location of a capture of the first image and a location of a capture of the second image.

19. A non-transitory computer readable medium stored thereon instruction to be executed by a processor associated with an image capturing device, the instructions comprising:
designating a first person appearing in a first image stored in a storage-unit associated with the device;
designating a second person appearing in a second image stored in the storage-unit;
calculating a first probability that the first person is the operator of the device;
calculating a second probability that the second person is the operator of the device; and
comparing the first probability to the second probability and determining which one of the first person or the second person is the operator of the device.

20. The non-transitory computer readable medium of claim 19, wherein calculating at least one of: the first probability and the second probability comprises finding a presence in the first image of an imager identified as an imager that captured the first image.
